(19) United States
(12) Patent Application Publication
(10) Pub. No.: US 2026/0351541 A1
(43) Pub. Date: Nov. 5, 2026

(54) ASSEMBLY, SAMPLE PLATE MOVING DEVICE, AND ANALYSIS APPARATUS

(71) Applicant: SHIMADZU CORPORATION, Kyoto-shi, Kyoto (JP)

(72) Inventor: Yohei TOJI, Kyoto-shi (JP)

(73) Assignee: SHIMADZU CORPORATION, Kyoto-shi, Kyoto (JP)

(21) Appl. No.: 19/486,137

(22) PCT Filed: Jan. 29, 2024
(86) PCT No.: PCT/JP2024/002661

§ 371 Date: Nov. 20, 2025

(30) Foreign Application Priority Data
May 31, 2023 (JP) 2023-089796

(51) Int. Cl. H01J 49/04

(52) U.S. Cl. CPC H01J 49/0409

(57) ABSTRACT

An assembly includes a vacuum chamber in which a through-hole is formed, a cover member attached to close the through-hole, a magnetic coupling including one magnetic coupling member on a side closer to the vacuum chamber than a portion of the cover member corresponding to the through-hole and the other magnetic coupling member on a side farther from the vacuum chamber than the portion, the magnetic coupling being installed to sandwich the portion, and a drive unit that drives the other magnetic coupling member, wherein the one magnetic coupling member is accommodated in an accommodation space defined by the through-hole and the cover member.

### TECHNICAL FIELD

The technology of the present disclosure relates to an assembly, a sample plate moving device, and an analysis apparatus.

### BACKGROUND ART

Patent Literature 1 discloses a structure in which power from a motor outside a vacuum chamber is transmitted into the vacuum chamber via a pair of magnetic couplings. In this structure, recesses are provided on the outside and inside of a partition plate of the vacuum chamber, and a pair of magnetic couplings are installed in a thin-walled portion formed by the recesses.

### Citation List

### Patent Literature

[Patent Literature 1] JP 2001-152320 A

### SUMMARY OF INVENTION

### Technical Problem

However, in the above structure, since it is necessary to accommodate a drive mechanism and one magnetic coupling member inside the vacuum chamber, the chamber space of the vacuum chamber is large, and a dead space is formed.

The technology of the present disclosure has been made in view of the above circumstances, and an object thereof is to provide an assembly, a sample plate moving device, and an analysis apparatus that can reduce the chamber space of the vacuum chamber as compared with the related art.

### Solution to Problem

To achieve the above object, an assembly according to a first aspect of the technology of the present disclosure includes: a vacuum chamber in which a through-hole is formed; a cover member attached to close the through-hole; a magnetic coupling including one magnetic coupling member on a side closer to the vacuum chamber than a portion of the cover member corresponding to the through-hole and the other magnetic coupling member on a side farther from the vacuum chamber than the portion, the magnetic coupling being installed to sandwich the portion; and a drive unit that drives the other magnetic coupling member, wherein the one magnetic coupling member is accommodated in an accommodation space defined by the through-hole and the cover member.

In a sample plate moving device according to a second aspect, in the assembly of the first aspect, the one magnetic coupling member of the pair of magnetic couplings on the vacuum chamber side is a sample plate, and the drive unit moves the sample plate by moving the other magnetic coupling member.

A third aspect is an analysis apparatus including the sample plate moving device of the second aspect, in which a sample is placed on the sample plate, and the sample is analyzed, the analysis apparatus including: an irradiation unit that irradiates the sample with an electromagnetic wave or an electron beam; a detection unit that detects a response of the sample irradiated with the electromagnetic wave or the electron beam; and an analysis unit that analyzes the sample based on the detected response.

### Advantageous Effects of Invention

The technology of the present disclosure can reduce the chamber space of a vacuum chamber as compared with the related art.

### BRIEF DESCRIPTION OF DRAWINGS

FIG. 1 is a cross-sectional view of an assembly according to an embodiment.

FIG. 2 is a cross-sectional view of an assembly according to a first modification.

FIG. 3 is a cross-sectional view of an assembly according to a second modification.

FIG. 4A is a cross-sectional view of an assembly according to a third modification.

FIG. 4B is a side view of the assembly according to the third modification.

FIG. 5 is a configuration diagram showing a MALDI-TOFMS.

### DESCRIPTION OF EMBODIMENTS

### Embodiment

Hereinafter, embodiments of the technology of the present disclosure will be described with reference to the drawings.

### Configuration

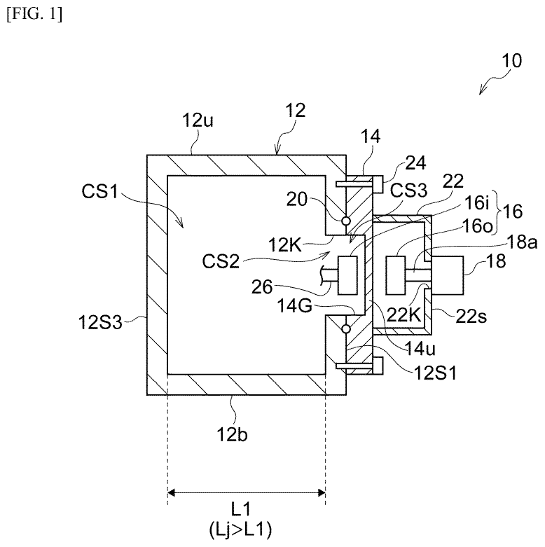

FIG. 1 is a cross-sectional view of an assembly 10 according to the embodiment. As shown in FIG. 1, the assembly 10 includes a vacuum chamber 12 in which a through-hole 12K is formed, a cover member 14 attached to close the through-hole 12K, a magnetic coupling 16 including one magnetic coupling member 16i on a side closer to the vacuum chamber 12 than a thin-walled portion 14u (described later) of the cover member 14 corresponding to the through-hole and the other magnetic coupling member 160 on a side farther from the vacuum chamber 12 than the thin-walled portion 14u, the magnetic coupling 16 being installed to sandwich the thin-walled portion 14u, and a drive unit 18 that drives the other magnetic coupling member 16o.

The vacuum chamber 12 includes a top plate 12u, a bottom plate 12b, and four side plates (12s1, 12s3). FIG. 1 shows the side plate 12S1 at the right end and the side plate 12S3 at the left end among the four side plates. The top plate 12u, the bottom plate 12b, and the four side plates (12s1, 12s3) are flat plates. The shape of the space of the vacuum chamber 12 is a rectangular parallelepiped. The shape of the space of the vacuum chamber 12 is not limited to a rectangular parallelepiped, and may be, for example, a cylindrical shape or another three-dimensional shape.

A through-hole 12K is formed in one (at the right end in FIG. 1) of the four side plates, the side plate 12S1. The shape of the cross section of the through-hole 12K is circular, and the shape of the space formed by the through-hole 12K is cylindrical.

The cover member 14 is attached to the side plate 12S1 so as to close the through-hole 12K. The cover member 14 is formed with a recessed portion 14G on the side where it is attached to the vacuum chamber 12. By forming the recessed portion 14G in the cover member 14, a thin-walled portion 14u is formed in the cover member 14. The shape of the cross section of the recessed portion 14G is circular, and the shape of the space formed by the recessed portion 14G is cylindrical.

An accommodation space for accommodating the one magnetic coupling member 16i is defined by the space formed by the through-hole 12K and the space formed by the recessed portion 14G. As described above, in the present embodiment, the recessed portion 14G forms an accommodation portion that accommodates the one magnetic coupling member 16i, and the accommodation portion constitutes a part of the accommodation space.

The cylindrical shape of the through-hole 12K and the cylindrical shape of the recessed portion 14G have the same cross-sectional shape and size. The cover member 14 is disposed on the side plate 12S1 such that the central axis of the cylindrical shape of the through-hole 12K and the central axis of the cylindrical shape of the recessed portion 14G coincide.

The chamber space of the assembly 10 is defined by a first chamber space CS1 defined by the top plate 12u, the bottom plate 12b, and the four side plates (12s1, 12s3), a second chamber space CS2 having the cylindrical shape of the through-hole 12K, and a third chamber space CS3 having the cylindrical shape of the recessed portion 14G. As described above, the one magnetic coupling member 16i is accommodated in the accommodation space defined by the second chamber space CS2 formed by the through-hole 12K and the third chamber space CS3 formed by the recessed portion 14G. Therefore, the end of the one magnetic coupling member 16i on the side of the other magnetic coupling member 16o is located outside the chamber space CS1 of the vacuum chamber 12.

One end of a movable part 26 is connected to the one magnetic coupling member 16i. An unillustrated operating mechanism that operates based on the rotation of the movable part 26 is connected to the other end of the movable part 26.

The assembly 10 includes a seal member 20 that seals between the side plate 12S1 of the vacuum chamber 12 and the cover member 14. The seal member 20 is, for example, an O-ring. The side plate 12S1 and the cover member 14 are connected by screws 24 with the seal member 20 sandwiched between the side plate 12S1 of the vacuum chamber 12 and the cover member 14. In this way, the space between the side plate 12S1 of the vacuum chamber 12 and the cover member 14 can be sealed.

The drive unit 18 is a motor that drives, in this embodiment, rotates, the other magnetic coupling member 16o of the pair of magnetic couplings 16. The drive unit 18 may be a prime mover. A rotation shaft 18a of the drive unit 18 is connected to the center of rotation of the other magnetic coupling member 16o.

The assembly 10 includes a fixing component 22 to which the drive unit 18 is fixed, for fixing the drive unit 18 to the cover member 14. The fixing component 22 has a cylindrical shape (box), is open on the cover member 14 side, and includes an end face portion 22S on the side opposite to the cover member 14 side, in which an opening 22K is formed. The rotation shaft 18a of the drive unit 18 passes through the opening 22K of the end face portion 22S. The end of the fixing component 22 on the cover member 14 side is welded to the cover member 14. In this way, the drive unit 18 can be fixed to the cover member 14 via the fixing component 22.

The drive unit 18, the fixing component 22, the cover member 14, and the magnetic coupling 16 are unitized (i.e., integrated).

### Method of Manufacturing Assembly 10

The drive unit 18, the fixing component 22, the cover member 14, and the magnetic coupling 16 are assembled and unitized while being detached from the vacuum chamber 12. When unitizing the drive unit 18, the fixing component 22, the cover member 14, and the magnetic coupling 16, the distance between the cover member 14 and the magnetic coupling 16 (16i, 16o) is adjusted. The unitized drive unit 18, fixing component 22, cover member 14, and magnetic coupling 16 are attached to the vacuum chamber 12. Specifically, the cover member 14 is disposed on the side plate 12S1 such that the central axis of the cylindrical shape of the through-hole 12K and the central axis of the cylindrical shape of the recessed portion 14G coincide. When disposing the cover member 14 on the side plate 12S1, the seal member 20 is positioned between the side plate 12S1 and the cover member 14. In this state where the seal member 20 is sandwiched between the side plate 12S1 of the vacuum chamber 12 and the cover member 14, the side plate 12S1 and the cover member 14 are connected by the screws 24. The chamber spaces of the assembly 10 (the first chamber space CS1, the second chamber space CS2, and the third chamber space CS3) are evacuated by a vacuum pump (not shown).

### Operation

The drive unit 18 rotates the rotation shaft 18a. When the rotation shaft 18a of the drive unit 18 rotates, the other magnetic coupling member 16o rotates. When the other magnetic coupling member 16o rotates, the one magnetic coupling member 16i, which is installed in the second chamber space CS2 and the third chamber space CS3 with the thin-walled portion 14u interposed therebetween, rotates following the other magnetic coupling member 16o. When the one magnetic coupling member 16i rotates, the movable part 26 connected to the one magnetic coupling member 16i rotates, and the aforementioned operating mechanism operates.

### Effects

As described above, in the present embodiment, the chamber space of the assembly 10 is defined by the first chamber space CS1 defined by the top plate 12u, the bottom plate 12b, and the four side plates (12s1, 12s3), the second chamber space CS2 having the cylindrical shape of the through-hole 12K, and the third chamber space CS3 having the cylindrical shape of the recessed portion 14G. In the related art, the one magnetic coupling member 16i, which is entirely disposed in the first chamber space CS1, can be moved to the side of the second chamber space CS2 and the third chamber space CS3 together with the movable part 26 in the present embodiment. Therefore, the distance between the side plate 12S3 and the side plate 12S1 can be made shorter than in the related art. Specifically, in the present embodiment, the length between the side plate 12S1 and the side plate 12S3 is L1. In the related art, the length between the side plate 12S1 and the side plate 12S3 is Lj. L1 is shorter than Lj. Therefore, the first chamber space CS1 can be made smaller than in the related art, and the dead space can be reduced.

Here, since the size of the cross section of the cylindrical shape of the through-hole 12K and the cylindrical shape of the recessed portion 14G along the side plate 12S1 is a part of the side plate 12S1, the amount of reduction in the volume of the first chamber space CS1 compared to the related art is larger than the total volume of the second chamber space CS2 and the third chamber space CS3. Therefore, the present embodiment can make the entire chamber space of the assembly 10 smaller than in the related art.

By the way, if moisture is present in the chamber space of the assembly 10 before the chamber space of the assembly 10 is evacuated, the moisture also adheres to the inner wall of the chamber space of the assembly 10. When a vacuum pump is operated to evacuate the chamber space of the assembly 10, moisture molecules present in the chamber space of the assembly 10 and moisture molecules that have adhered to the inner wall of the assembly 10 are discharged. This is outgassing. Since the present embodiment can make the chamber space of the assembly 10 smaller than in the related art, the area of the inner wall of the assembly 10 can be reduced. If the chamber space of the assembly 10 and the area of the inner wall can be reduced, the amount of moisture present in the chamber space and adhering to the inner wall is reduced, and thus outgassing is reduced. As described above, the present embodiment can reduce outgassing as compared with the related art.

Further, since the present embodiment can make the chamber space of the assembly 10 smaller than in the related art, the assembly 10 can be made smaller and lighter.

Furthermore, in the present embodiment, since the drive unit 18, the fixing component 22, the cover member 14, and the magnetic coupling 16 are unitized, they can be assembled while being detached from the vacuum chamber 12. Therefore, in the present embodiment, the distance between the cover member 14 and the magnetic coupling 16 (16i, 16o) can be easily adjusted during assembly.

### Modifications

Next, modifications will be described. Since each modification described below has the same configuration as the embodiment, the same parts are denoted by the same reference numerals, and a description thereof will be omitted.

### First Modification

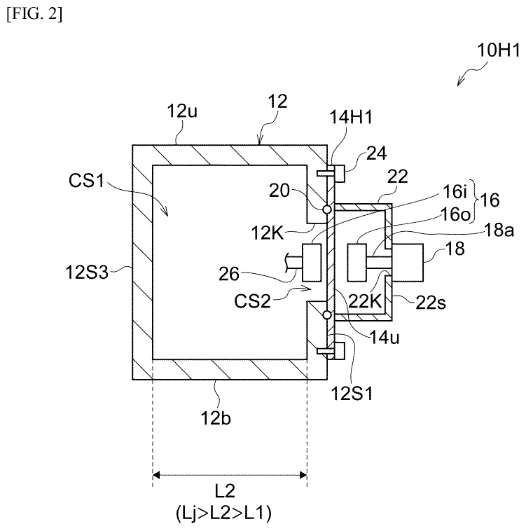

FIG. 2 is a cross-sectional view of an assembly 10H1 according to a first modification.

In the cover member 14 (see FIG. 1) of the above-described embodiment, the recessed portion 14G is formed on the side where it is attached to the vacuum chamber 12.

In contrast, the cover member 14H1 of the first modification is a flat plate in which the recessed portion 14G is not formed. The thickness of the cover member 14H1 is, for example, the same as the thickness of the thin-walled portion 14u of the cover member 14 of the above-described embodiment. The thickness of the cover member 14H1 may be larger or smaller than the thickness of the thin-walled portion 14u. In the first modification, the accommodation space for accommodating the one magnetic coupling member 16i is defined only by the space formed by the through-hole 12K. In the first modification, the recessed portion 14G is an accommodation portion and constitutes the entire accommodation space. In the first modification, similarly to the above-described embodiment, the drive unit 18, the fixing component 22, the cover member 14H2, and the magnetic coupling 16 are unitized.

In the first modification, the end of the one magnetic coupling member 16i on the side of the other magnetic coupling member 16o is located outside the chamber space CS1 of the vacuum chamber 12, specifically, in the second chamber space CS2 having the cylindrical shape of the through-hole 12K. Therefore, the distance between the side plate 12S3 and the side plate 12S1 can be made shorter than in the related art. Specifically, in the present embodiment, the length L2 (>L1) between the side plate 12S1 and the side plate 12S3 is shorter than the length Lj between the side plate 12S1 and the side plate 12S3 in the related art. Therefore, the first chamber space CS1 can be made smaller than in the related art, and the dead space can be reduced. Since the first chamber space CS1 can be made smaller than in the related art, the chamber space of the assembly 10H1 can be made smaller than in the related art.

Similarly to the above embodiment, the first modification can reduce outgassing as compared with the related art, the assembly 10 can be made smaller and lighter, and the distance between the cover member 14 and the magnetic coupling 16 (16i, 16o) can be easily adjusted during assembly.

### Second Modification

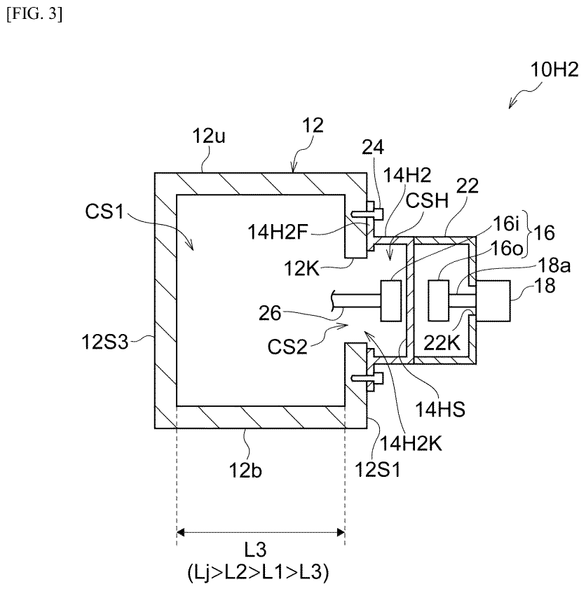

FIG. 3 is a cross-sectional view of an assembly 10H2 according to a second modification. As shown in FIG. 3, the assembly 10H2 includes a cover member 14H2 instead of the cover member 14 (see FIG. 1) of the embodiment. The cover member 14H2 is a box body (cylindrical shape) having an opening 14H2K formed at one end on the vacuum chamber 12 side. The magnetic coupling 16 is installed to sandwich an end face portion 14HS at the other end of the box body.

A flange portion 14H2F is provided at the end of the cover member 14H2 on the vacuum chamber 12 side, the flange portion 14H2F is disposed on the side plate 12S1 of the vacuum chamber 12, and the flange portion 14H2F is fixed to the side plate 12S1 of the vacuum chamber 12 with screws 24. The end of the fixing component 22 on the cover member 14H2 side is welded to the end face portion 14HS of the cover member 14H2. In the second modification, similarly to the above-described embodiment, the drive unit 18, the fixing component 22, the cover member 14H2, and the magnetic coupling 16 are unitized.

The chamber space of the assembly 10H2 is defined by the first chamber space CS1, the second chamber space CS2, and a chamber space CSH of the box body of the cover member 14H2. Here, the thickness of the chamber space CSH is larger than the thickness of the third chamber space CS3 of the above embodiment. Therefore, the distance between the side plate 12S3 and the side plate 12S1 can be made shorter than in the above embodiment. Specifically, in the second modification, the length L3 between the side plate 12S1 and the side plate 12S3 is shorter than Lj, L2, and L1 (Lj>L2>L1>L3). The second modification can make the chamber space of the assembly 10 smaller than the above embodiment.

Similarly to the above embodiment, the second modification can reduce outgassing as compared with the related art, the assembly 10H2 can be made smaller and lighter, and the distance between the cover member 14 and the magnetic coupling 16 (16i, 16o) can be easily adjusted during assembly.

### Third Modification

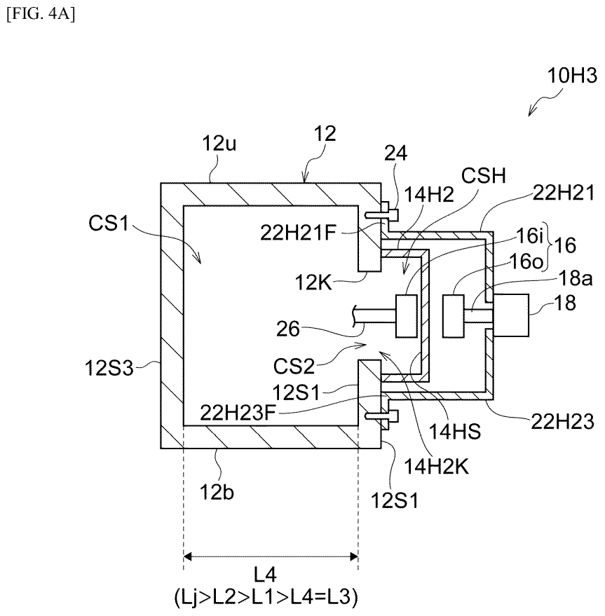

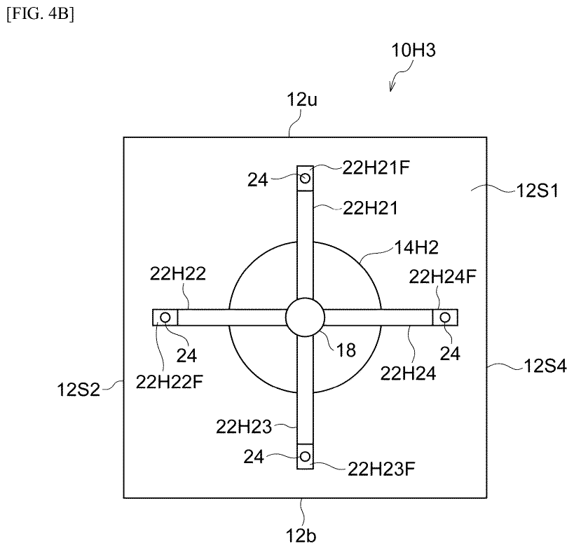

FIG. 4A is a cross-sectional view of an assembly 10H3 according to a third modification. FIG. 4B is a side view of the assembly 10H3 according to the third modification.

Since the assembly 10H3 of the third modification has the same configuration as the assembly 10H2 of the second modification, the same parts are denoted by the same reference numerals, and a description thereof will be omitted.

The assembly 10H3 of the third modification includes, instead of the fixing component 22, a plurality of bracket components 22H21 to 22H24, each having one end supporting the drive unit 18 and the other end attached to the vacuum chamber 12. In the third modification, four bracket components are provided, but the number is not limited to four, and may be two, three, five, six, or the like. Flange portions 22H21F to 22H24F are provided at the other ends of the plurality of bracket components 22H21 to 22H24. The flange portions 22H21F to 22H24F are disposed on the side plate 12S1 of the vacuum chamber 12, and the flange portions 22H21F to 22H24F are fixed to the side plate 12S1 of the vacuum chamber 12 with screws 24. The other ends of the plurality of bracket components 22H21 to 22H24 may be attached to the cover member 14H2. The rotation shaft 18a of the drive unit 18 is located in a region surrounded by one ends of the bracket components 22H21 to 22H24.

In the third modification, similarly to the second modification, the length L4 (=L3) between the side plate 12S1 and the side plate 12S3 is shorter than Lj, L2, and L1 (Lj>L2>L1>L4), and the chamber space of the assembly 10H3 can be made smaller. Similarly to the second modification, the third modification can reduce outgassing as compared with the related art, the assembly 10H3 can be made smaller and lighter, and the distance between the cover member 14H2 and the magnetic coupling 16 (16i, 16o) can be easily adjusted during assembly.

Since the third modification includes the bracket components 22H21 to 22H24, the magnetic coupling 16 can be easily arranged.

In the above embodiment, the first modification, and the second modification, the bracket components 22H21 to 22H24 of the third modification may be used instead of the fixing component 22.

### Application Example

### Sample Plate Moving Device

The assemblies 10, 10H1, 10H2, and 10H3 of the embodiment and each modification can be applied to a sample plate moving device for moving a sample plate within the vacuum chamber 12. Specifically, in the sample plate moving device, the one magnetic coupling member 16i of the pair of magnetic couplings 16 on the vacuum chamber 12 side is a sample plate. The drive unit 18 moves the one magnetic coupling member 16i on the vacuum chamber 12 side in a planar manner by driving the other magnetic coupling member 16o, specifically, by moving it in a planar manner (that is, along a plane, within a plane).

### Analysis Apparatus

The sample plate moving device is used in an analysis apparatus. The analysis apparatus includes the sample plate moving device, a sample is placed on the sample plate, and the sample is analyzed. Specifically, the analysis apparatus includes an irradiation unit that irradiates the sample with an electromagnetic wave or an electron beam, a detection unit that detects a response of the sample irradiated with the electromagnetic wave or the electron beam, and an analysis unit that analyzes the sample based on the detected response.

For example, the sample plate moving device is disclosed in JP 2019-114562 A. The sample plate moving device is used in an analysis apparatus as described in JP 2019-114562 A.

As the analysis apparatus, for example, there is a Matrix Assisted Laser Desorption Ionization/Time of Flight Mass Spectrometer (MALDI-TOFMS) 101.

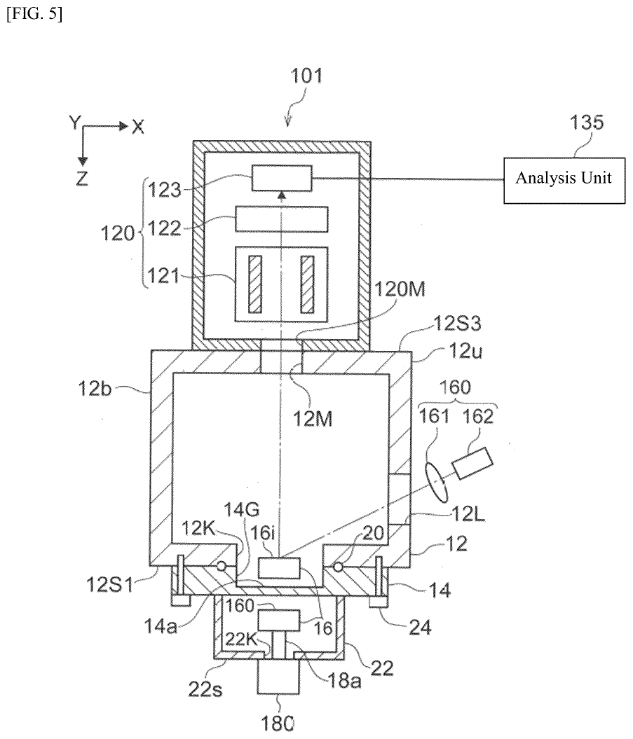

FIG. 5 is a configuration diagram showing the MALDI-TOFMS 101. It is assumed that one direction horizontal to the ground is an X direction, a direction horizontal to the ground and perpendicular to the X direction is a Y direction, and a direction perpendicular to the X direction and the Y direction is a Z direction.

The MALDI-TOFMS 101 includes a vacuum chamber 12, a detection unit 120 provided in connection with the vacuum chamber 12, and a vacuum pump (not shown) that evacuates the inside of the vacuum chamber 12. The MALDI-TOFMS 101 includes a sample plate driving unit 180 that drives a sample plate (one magnetic coupling member) 16i on which a sample is placed and which is disposed inside the vacuum chamber 12. The sample plate driving unit 180 moves the sample plate 16i in a planar manner (that is, along a plane, within a plane). The MALDI-TOFMS 101 includes an irradiation unit 160 that irradiates the sample with laser light, and a detection unit 120 that detects vaporized sample or ions emitted from the sample irradiated with the laser light. The MALDI-TOFMS 101 includes an analysis unit 135 that creates a mass spectrum of the sample based on the detected vaporized sample or ions, and performs qualitative analysis and quantitative analysis based on this mass spectrum.

The sample plate driving unit 180 includes, for example, an X-axis linear actuator and a Y-axis linear actuator, and moves the sample plate 16i by moving the other magnetic coupling member 160 of the vacuum chamber 12 with the X-axis linear actuator and the Y-axis linear actuator.

In the vacuum chamber 12, an irradiation window 12L that transmits laser light is formed in a top plate (a side plate in this example) 12u, and a passage window 12M for passage of vaporized sample or ions is formed in a side plate 12S3. In the detection unit 120, a passage window 120M corresponding in size and position to the passage window 12M is formed.

The irradiation unit 160 is disposed so as to be located at the upper right outside the vacuum chamber 12, and includes a laser condensing optical system 161 and a laser irradiation unit 162. According to such an irradiation unit 160, laser light for ionization emitted from the laser irradiation unit 162 is focused by the laser condensing optical system 161 and irradiated toward the sample on the sample plate 16i through the irradiation window 12L of the vacuum chamber 12.

Ions emitted from the sample by laser irradiation from the irradiation unit 160 are introduced into the detection unit 120 via the passage windows 12M and 120M, sent to a mass analyzer 122 via an ion transport optical system 121, and various ions are separated by the mass analyzer 122 according to their mass-to-charge ratio. Then, when the separated ions reach an ion detection unit 123, the ion detection unit 123 outputs a detection signal corresponding to the amount of reached ions, and this detection signal is transmitted to the analysis unit 135. The analysis unit 135 creates a mass spectrum of the sample and performs qualitative analysis and quantitative analysis based on this mass spectrum.

The analysis apparatus is not limited to the MALDI-TOFMS 1, and may be an energy dispersive X-ray fluorescence spectrometer (EDX (Energy Dispersive X-ray Spectroscopy), described in JP 2020-201115 A, etc.), an X-ray diffraction apparatus (XRD (X-ray Diffraction), described in JP 2020-201148 A, etc.), an electron probe microanalyzer (EPMA (Electron Probe Micro Analyzer), described in JP 2021-032584 A, etc.), a scanning probe microscope (SPM (Scanning Probe Microscope), described in JP 2022-181852 A, etc.), a scanning electron microscope (SEM (Scanning Electron Microscope), described in JP 2019-003863 A, etc.), an X-ray photoelectron spectroscopy apparatus (XPS (X-ray Photoelectron Spectroscopy), described in Japanese Utility Model Registration No. 3112036), or the like.

The descriptions and illustrations presented above are detailed explanations of the parts related to the technology of the present disclosure, and are merely examples of the technology of the present disclosure. For example, the descriptions regarding the above-mentioned configurations, functions, operations, and effects are examples of the configurations, functions, operations, and effects of the parts related to the technology of the present disclosure. Therefore, it goes without saying that unnecessary parts may be deleted, new elements may be added, or replacements may be made to the descriptions and illustrations presented above within a scope that does not depart from the gist of the technology of the present disclosure. Also, in order to avoid complexity and facilitate understanding of the parts related to the technology of the present disclosure, descriptions of common technical knowledge and the like that do not require particular explanation for enabling the implementation of the technology of the present disclosure are omitted from the descriptions and illustrations presented above.

All documents, patent applications, and technical standards cited in this specification are incorporated herein by reference to the same extent as if each individual document, patent application, and technical standard were specifically and individually indicated to be incorporated by reference.

### Aspects

It will be understood by those skilled in the art that the above-described embodiments are specific examples of the following aspects.

### Item 1

An assembly, comprising:
a vacuum chamber in which a through-hole is formed;
a cover member attached to close the through-hole;
a magnetic coupling including one magnetic coupling member on a side closer to the vacuum chamber than a portion of the cover member corresponding to the through-hole and the other magnetic coupling member on a side farther from the vacuum chamber than the portion, the magnetic coupling being installed to sandwich the portion; and
a drive unit that drives the other magnetic coupling member,
wherein the one magnetic coupling member is accommodated in an accommodation space defined by the through-hole and the cover member.

According to the assembly of item 1, the chamber space of the assembly can be made smaller than in the related art.

### Item 2

The assembly according to item 1, wherein an end of the one magnetic coupling member on a side of the other magnetic coupling member is located outside a chamber space of the vacuum chamber.

According to the assembly of item 2, the chamber space of the vacuum chamber can be made smaller than in the related art, and the chamber space of the assembly can be made smaller than in the related art.

### Item 3

The assembly according to item 1 or 2,
wherein the cover member includes an accommodation portion that accommodates the one magnetic coupling member, and
the accommodation portion constitutes a part of the accommodation space.

According to item 3, the accommodation space can be enlarged, the chamber space of the vacuum chamber can be made smaller than in the related art, and the chamber space of the assembly can be made smaller than in the related art.

### Item 4

The assembly according to claim 3, wherein the accommodation portion is a recessed portion formed on a side of the portion of the cover member corresponding to the through-hole where the cover member is attached to the vacuum chamber.

According to item 4, the accommodation space can be enlarged, the chamber space of the vacuum chamber can be made smaller than in the related art, and the chamber space of the assembly can be made smaller than in the related art.

### Item 5

The assembly according to item 1 or 2, further comprising a seal member that seals between the vacuum chamber and the cover member.

According to the assembly of item 5, the chamber space of the assembly can be sealed.

### Item 6

The assembly according to item 1 or 2, wherein the drive unit is a motor or a prime mover that rotates the other magnetic coupling member.

According to the assembly of item 6, the one magnetic coupling member can be rotated by rotating the other magnetic coupling member.

### Item 7

The assembly according to item 1 or 2, further comprising a fixing component to which the drive unit is fixed,
wherein the fixing component is attached to the cover member or the vacuum chamber.

According to the assembly of item 7, the drive unit can be fixed.

### Item 8

The assembly according to item 7, wherein the fixing component includes a plurality of bracket components, each having one end supporting the drive unit and the other end attached to the cover member or the vacuum chamber.

According to item 8, the magnetic coupling can be easily arranged.

### Item 9

The assembly according to item 1 or 2,
wherein the cover member is a box body having an opening formed at one end on a side of the vacuum chamber,
the one end of the cover member is attached to the vacuum chamber, and
the magnetic coupling is installed to sandwich an end face portion at the other end of the box body.

According to item 9, the accommodation space can be made larger, the chamber space of the vacuum chamber can be made smaller than in the related art, and the chamber space of the assembly can be made smaller than in the related art.

### Item 10

The assembly according to claim 9, further comprising a fixing component to which the drive unit is fixed,
wherein the fixing component is a box body having an opening formed at one end on a side of the cover member, and
the one end of the box body of the fixing component is attached to the end face portion of the cover member.

According to the assembly of item 10, the drive unit can be fixed.

### Item 11

A sample plate moving device,
wherein, in the pair of magnetic couplings according to item 1 or 2, the one magnetic coupling member on the side of the vacuum chamber is a sample plate, and
the drive unit moves the sample plate by moving the other magnetic coupling member.

According to the sample plate moving device of item 11, the chamber space of the assembly can be made smaller than in the related art.

### Item 12

An analysis apparatus comprising the sample plate moving device according to item 11, wherein a sample is placed on the sample plate, and the sample is analyzed, the analysis apparatus comprising:
an irradiation unit that irradiates the sample with an electromagnetic wave or an electron beam;
a detection unit that detects a response of the sample irradiated with the electromagnetic wave or the electron beam; and
an analysis unit that analyzes the sample based on the detected response.

According to the analysis apparatus of item 12, the chamber space of the assembly can be made smaller than in the related art.

### REFERENCE SIGNS LIST

10 Assembly
12K Through-hole
12 Vacuum chamber
14 Cover member
16 Magnetic coupling
18 Drive unit
101 MALDI-TOFMS
120 Detection unit
16i Sample plate
18 Sample plate moving device
160 Irradiation unit
120 Detection unit
135 Analysis unit

1: An assembly comprising:
a vacuum chamber in which a through-hole is formed;
a cover member attached to close the through-hole;
a magnetic coupling including one magnetic coupling member on a side closer to the vacuum chamber than a portion of the cover member corresponding to the through-hole and the other magnetic coupling member on a side farther from the vacuum chamber than the portion, the magnetic coupling being installed to sandwich the portion; and
a drive unit that drives the other magnetic coupling member,
wherein the one magnetic coupling member is accommodated in an accommodation space defined by the through-hole and the cover member.

2: The assembly according to claim 1, wherein an end of the one magnetic coupling member on a side of the other magnetic coupling member is located outside a chamber space of the vacuum chamber.

3: The assembly according to claim 1,
wherein the cover member includes an accommodation portion that accommodates the one magnetic coupling member, and
the accommodation portion constitutes a part of the accommodation space.

4: The assembly according to claim 3, wherein the accommodation portion is a recessed portion formed on a side of the portion of the cover member corresponding to the through-hole where the cover member is attached to the vacuum chamber.

5: The assembly according to claim 1, further comprising a seal member that seals between the vacuum chamber and the cover member.

6: The assembly according to claim 1, wherein the drive unit is a motor or a prime mover that rotates the other magnetic coupling member.

7: The assembly according to claim 1, further comprising a fixing component to which the drive unit is fixed,
wherein the fixing component is attached to the cover member or the vacuum chamber.

8: The assembly according to claim 7, wherein the fixing component includes a plurality of bracket components, each having one end supporting the drive unit and the other end attached to the cover member or the vacuum chamber.

9: The assembly according to claim 1,
wherein the cover member is a box body having an opening formed at one end on a side of the vacuum chamber,
the one end of the cover member is attached to the vacuum chamber, and
the magnetic coupling is installed to sandwich an end face portion at the other end of the box body.

10: The assembly according to claim 9, further comprising a fixing component to which the drive unit is fixed,
wherein the fixing component is a box body having an opening formed at one end on a side of the cover member, and
the one end of the box body of the fixing component is attached to the end face portion of the cover member.

11: A sample plate moving device comprising the assembly according to claim 1,
wherein the one magnetic coupling member on the side of the vacuum chamber is a sample plate, and
the drive unit moves the sample plate by moving the other magnetic coupling member.

12: An analysis apparatus comprising the sample plate moving device according to claim 11, wherein a sample is placed on the sample plate, and the sample is analyzed, the analysis apparatus comprising:
an irradiation unit that irradiates the sample with an electromagnetic wave or an electron beam;
a detection unit that detects a response of the sample irradiated with the electromagnetic wave or the electron beam; and
an analysis unit that analyzes the sample based on the detected response.
